(19) United States
(12) Patent Application Publication
(10) Pub. No.: US 2008/0294492 A1
(43) Pub. Date: Nov. 27, 2008

(54) PROACTIVELY DETERMINING POTENTIAL EVIDENCE ISSUES FOR CUSTODIAL SYSTEMS IN ACTIVE LITIGATION

(76) Inventors: Irina Simpson, Sunnyvale, CA (US); Deidre Paknad, Palo Alto, CA (US)

Correspondence Address: GLENN PATENT GROUP, 3475 EDISON WAY, SUITE L, MENLO PARK, CA, 94025, US

(21) Appl. No.: 12/147,350

(22) Filed: Jun. 26, 2008

Related U.S. Application Data
(63) Continuation-in-part of application No. 11/807,145, filed on May 24, 2007.

(51) Int. Cl. G06Q 10/00; G06Q 50/00; G06F 17/30

(52) U.S. Cl. 705/9; 705/1

(57) ABSTRACT

The record of custodial systems' involvement in legal matters is coupled with a workflow that detects actual or planned changes affecting custodial systems themselves and/or their associations with other entities in the enterprise map, and that notifies the appropriate parties so the information is preserved.

### CROSS REFERENCE TO RELATED APPLICATION

This application is a continuation-in-part of U.S. patent application Ser. No. 11/807,145, filed May 24, 2007 and entitled Conducting Cross Checks on Legal Holds across Custodian or Custodial System, which application is incorporated herein in its entirety by this reference thereto.

### BACKGROUND OF THE INVENTION

1. Technical Field

Embodiments of the invention relate generally to data management. More particularly, the invention relates to software technology for ensuring potentially relevant information is not inadvertently destroyed during active litigation due to custodial system and related enterprise map changes.

2. Description of the Prior Art

A large enterprise maintains physical and electronic information in thousands of custodial systems in locations such as file servers, warehouses, email systems, records rooms, etc.

Litigation and regulation require that corporate information be managed in a proactive and systematic manner, including the ability to produce, on demand, such information for litigation, and the ability to define and execute legally sound policy regarding the information lifecycle.

Determining which custodial systems have potentially relevant data and evidence is difficult, given the large numbers of custodial systems, on-going changes in relationships between custodial systems, business departments, stewards (employees responsible for custodial systems within IT and business departments), and organization-specific classification codes (OSCCs) mapped to custodial systems.

Even after the information in custodial systems has been placed on legal hold and the appropriate stewards have been notified, changes in associations between custodial systems, employees, departments, and OSCCs due to employee turnover or re-assignments, data migration from one system to another, or other changes, create legal risk. The litigation group may need to capture and preserve information located in the custodial system affected by changes or notify new stewards of the legal holds associated with the system that became their responsibility.

It would be advantageous to provide a technique for coupling the record of custodial systems' involvement in legal matters, for example, with a workflow that detects actual or planned changes affecting custodial systems themselves and/or their associations with other entities in an enterprise map, and that notifies the appropriate parties so the information is preserved.

### SUMMARY OF THE INVENTION

The invention provides a method and apparatus for coupling the record of custodial systems' involvement in legal matters with a workflow that detects actual or planned changes affecting custodial systems themselves and/or their associations with other entities in the enterprise map, and that notifies the appropriate parties so the information is preserved.

### BRIEF DESCRIPTION OF THE DRAWINGS

FIG. 1 is a diagram of an exemplary environment in which embodiments of the present invention may be practiced;

FIG. 2 is a block diagram of an exemplary legal matter management system;

FIG. 3 is a block diagram of an exemplary legal communication and collection engine;

FIG. 4 is a schematic diagram of exemplary relationships between objects within a map of an enterprise;

FIG. 5 is a flowchart of an exemplary method for proactively determining potential evidence issues for custodial systems in active litigation;

FIG. 6 is a screen shot of a user interface providing a data source master list for a matter.

FIG. 7 is a screen shot of a user interface providing a list of affected data sources.

FIG. 8 is a screenshot of a user interface providing a list of affected people.

### DETAILED DESCRIPTION OF THE INVENTION

The invention provides a method and apparatus for coupling the record of custodial systems' involvement in legal matters with a mechanism that detects actual or planned changes affecting custodial systems themselves and/or their associations with other entities in the enterprise map, and triggers various workflows and notifications to the appropriate parties so the information is preserved.

### Components

The following components, discussed in greater detail below, and in connection with the figures herein, comprise a presently preferred embodiment of the invention:

A Legal Communications and Collections (LCC) application that allows attorneys and paralegals to manage preservation and production of information. This application preferably includes functions to:
Identify and record custodial systems involved or potentially involved in a legal matter and employees responsible for the systems, e.g. associated stewards and business owners.
Send legal notices to employees indicating actions to be taken including, for example, in connection with:
   Information—a hold notice indicating the requirement and obligation to preserve information;
   Knowledge—an interview request indicating the need to share or disclose knowledge; and
   Documents—a request to collect and produce information.

Sources of information about custodial system attributes, status, and associations with other entities in the enterprise map, for example:
An application, i.e. user interface, in the LCC or in another stand-alone application, that allows custodial system information, status changes or expected status changes, and associations between custodial systems, employees, Organizational-specific classification codes (OSCCs) and departments to be entered. OSCCs are detailed in U.S. patent application Ser. No. 11/505,665, filed on Aug. 16, 2006, and entitled “Systems and Methods for utilizing organization-specific classification codes” which is incorporated herein in its entirety by this reference thereto.
A central application for aggregating status information from various sources.
Any other system that can be a source of information.

The presently preferred method for executing the invention comprises, for example, the steps of:
1. Attorneys, paralegals, and other LCC users use the LCC application to identify the custodial systems involved and affected by legal matters, as well as the list of employees involved due to their association with an affected custodial system. This list is stored per legal matter and may include, for example:
   Systems associated with the departments involved in the matter;
   Global systems (always involved in any matters);
   Custodial systems mapped to the information types relevant to the matter;
   Any other system intersecting the matter;
   IT staff responsible for managing data or information repositories; and
   Records management staff responsible for information record keeping. Additional information about the matter, such as the Attorney and Paralegal and matter status (Active, Closed), is also stored in this system.
2. As custodial system attributes, status, or mapping associations change or are expected to change, the modification is communicated, signaled, queued, tagged, or otherwise indicated in an appropriate system, such as an enterprise mapping, and even directly into the LCC application itself. The change event signals the following information for one or more custodial systems, such as:
   Expected or actual status change indicating that the system is to be taken off line;
   Changes in relationships between custodial systems, e.g. change in back-up system used;
   Enterprise map changes that cause data migration; and
   Employee status or role assignment changes affecting custodial systems.
3. The custodial system change event is communicated to the LCC application logic. The event minimally contains, for example:
   An ID or other unique identifier indicating which custodial system is affected;
   Optionally, the expected or actual end date of operation, which may be past or future, if known; and
   Optionally, other custodial system information, including associations with other entities in the enterprise map.

Multiple events may be communicated for the same custodial system in case of several changes, e.g. multiple new or modified relationships between custodial systems or associations with other entities in the enterprise map.
4. Based upon the change events, the LCC application performs a variety of functions, for example:
   Notification—appropriate parties, such as relevant business department and IT staff, are notified of the event so that action can be taken to preserve the information. In some embodiments of the present invention, one or more “notification list” is provided that lists the appropriate parties who should receive this information. For each legal matter that is currently Active, the list of involved and affected custodial systems for the system indicated in the event is searched. If the system is found in the matter, then:
      Notify (alert) one or more individuals selected from among an Attorney, a Paralegel and other appropriate individuals on the one or more notification lists for each Matter that swift action needs to be taken to preserve the data;
      Send a legal notice to appropriate staff associated with the custodial system, such as IT, business owners, etc., informing them of the preservation obligations regarding the system; and
      If a legal notice was sent, record the legal notice, date of transmission and all notice recipients in the LCC application to create an audit trail.
   Workflow—workflow processes can be triggered to manage the collection and processing, providing instructions, assignment, tracking of timely task completion, and exception handling for errors or incomplete tasks.
      The LCC application creates workflow items to track the status of the information preservation, and to prompt relevant employees, e.g. attorney, paralegal, IT, to confirm and validate that actions have been taken, and to handle exceptions when this is not done in a timely manner. This workflow can be driven by the actual status of the custodial system within each active legal Matter, i.e.: Are there legal holds? Are there open collection requests?, etc.
   Reporting—search and reporting tools provide a list of all matters involving the custodial system, including the status of information that may have been or may need to be collected or otherwise preserved.

Further embodiments of the invention include:
Steps 1 and 4 above—custodial systems that are involved or affected by a legal matter may include systems derived using the Key Player identification algorithm detailed in U.S. patent application Ser. No. 11/505,537, filed Aug. 29, 2006 and entitled “Deriving Key Players and Systems for Litigation Holds and Discovery”, which is incorporated herein in its entirety by this reference thereto.
Step 4, Notification—alerting the attorney and paralegal may be done by email, pager, or any other common method. Furthermore, escalation and wider alerting, e.g. other legal staff, may be done when very swift reaction by the legal team is required.
Step 4, Notification,—sending legal notice to appropriate staff:
   The IT staffs that are assuming responsibility for the system are notified of actions that must be taken and the workflow is used to track their completion.
   In case of system retirement, the IT staffs responsible for the custodial system are notified of actions that must be taken and the workflow is used to track their completion.
Records management and compliance personnel responsible for the information stored in the system are notified. Appropriate parties are identified from a directory of records management/compliance personnel by organization.
Active Monitoring—the LCC application supports ability of legal staff to monitor the custodial system attribute and status changes actively, and the processing of these changes:
   Ability to subscribe to status change notifications and/or see summary reports of all status changes that have occurred, for example a summary report that shows custodial systems with outstanding collections, the list of affected custodial systems for a single matter, or any other permutation.
   Ability to see workflow status, i.e. whether preservation efforts have been taken, exceptions (overdue) actions, etc.
   Dashboard functionality that summarizes the above.
   Review/audit capability of the above.
All Steps—a record (history) of all steps, intervention and collections of information from the custodial system affected by changes during the matter is created, and is part of the preservation and matter record.

### A PREFERRED EMBODIMENT OF THE INVENTION

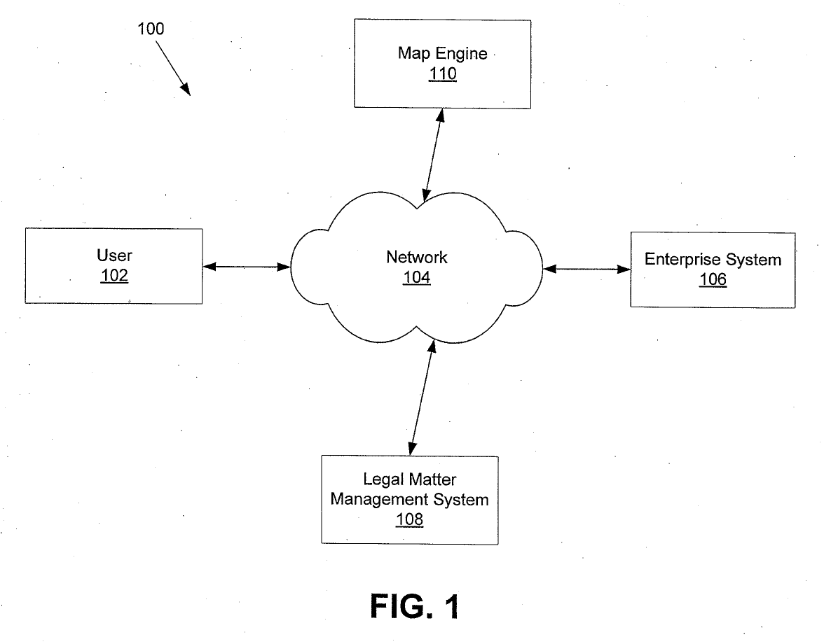

FIG. 1 shows an exemplary environment 100 in which embodiments of the invention may be practiced. The environment 100 comprises at least one user 102 coupled via a network 104 to an enterprise system 106. In exemplary embodiments, the network 104 may be a local area network, a wide area network, peer-to-peer network, or the Internet. Alternatively, the user 102 may be coupled directly to the enterprise system 106 or access the enterprise system 106 from within the enterprise system 106. In some embodiments, more than one network 104 and/or more than one type of network 104 may be used to allow the components of the environment 100 to communicate with each other.

Any number of users 102 may be present in the environment 100. The user 102 may be an individual who accesses the legal matter management engine 108 via a computing device associated with the user 102. In exemplary embodiments, the matter is a legal matter, and may comprise, for example, a pending or potential litigation, tax inquiry, or regulatory inquiry matter. In these embodiments, the user 102 may comprise an attorney or legal staff associated with the legal matter. However, in alternative embodiments, the matter may be related to any matter of interest to the user 102, e.g. internal investigation, policy-related examination/investigation, or audit. For simplicity of discussion, the following description will be presented with reference to a legal matter. However, it is understood that embodiments of the invention may be applied to any type of matter.

In some embodiments, a computing device associated with the user 102 may comprise an optional business application (not shown) that performs actions related to the enterprise map. For example, the business application may interact with a legal matter management system 108. In an alternative embodiment, the business application may comprise the legal matter management system 108 and/or a map engine 110 that generates the enterprise map. In other embodiments, the business application interacts with a user interface module in the map engine 110 and/or the legal management system 108, as will be discussed below.

The exemplary enterprise system 106 may comprise any number of servers, client devices, and repositories comprising data. The enterprise system 106 may further comprise a totality of IT, storage and information management systems in an enterprise, including those internally managed, outsourced, etc. The data may comprise documents, files, audio and video media, e-mail communication, and any other information which may be stored in repositories. Repositories may comprise both physical and digital storage media including warehouses, filing cabinets, hard drives, and other digital media storage devices. The repositories may be located anywhere in an enterprise, e.g. in different jurisdictions.

The exemplary map engine 110 maintains a map comprising a structure that represents people, repositories, organizations, and documents via relationships. The map engine 110 uses information types, organizations, storage locations, people, and other objects and their relationships to provide an overall map structure that is used to derive relationships between people, repositories, and organizations. As a result, the user 102 can use the map to determine affected people and systems in the enterprise system 106. The map engine 110 and creation of the enterprise map is described in further detail in co-pending U.S. patent application Ser. No. 11/512,880, filed Aug. 29, 2006, entitled Systems and Methods for Providing a Map of an Enterprise System, and U.S. patent application Ser. No. 11/505,537, filed Aug. 16, 2006, entitled Systems and Methods for Utilizing an Enterprise Map to Determine Affected Entities, both of which are incorporated herein in their entirety by this reference thereto. While the map engine 110 is shown coupled to the enterprise system 106, the map engine 110 may be comprised within the enterprise system 106, according to some embodiments of the present invention.

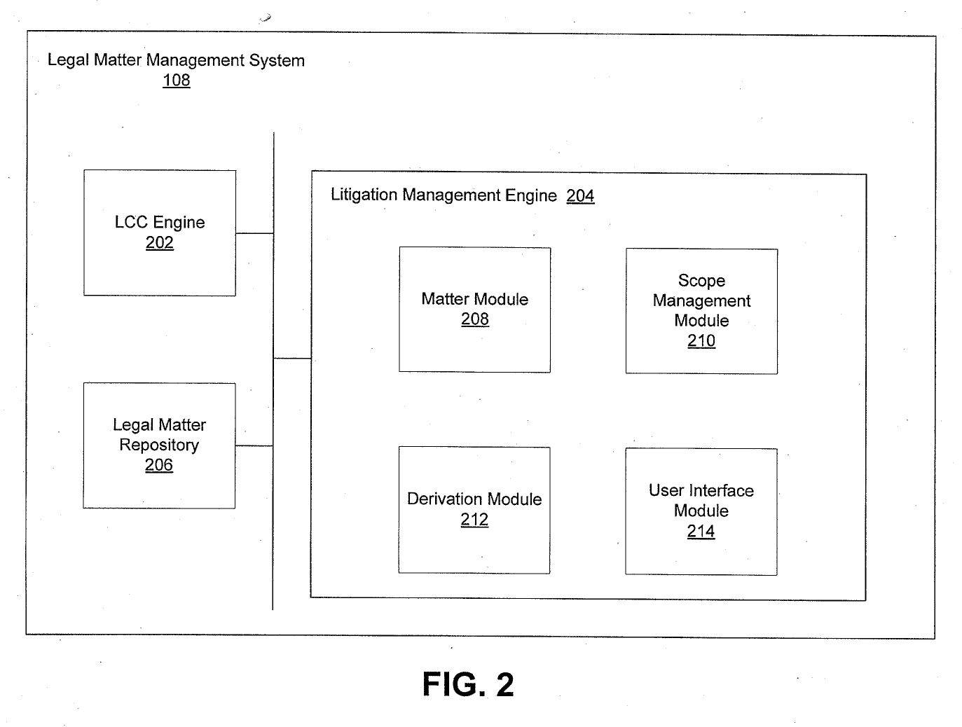

The legal matter management system 108 is configured to allow users to manage preservation and production of data associated with legal matters. The exemplary legal matter management system 108 is discussed herein as being used to determine affected people and systems associated with the legal matters. However, the legal matter management system 108 may be used to determine affected people and systems for any reason. For example, the user 102 may use the legal management system 108 to find affected people and systems associated with a merger transaction to review, hold/preserve, or collect certain documents, or to interview the affected people. While the legal matter management system 108 is shown coupled to the enterprise system 106, the legal matter management system 108 may be embodied within the enterprise system 106, in various embodiments of the present invention. The legal matter management system 108 will be discussed in more detail in connection with FIG. 2.

It should be noted that the environment 100 of FIG. 1 is exemplary. Alternative embodiments may, for example, comprise the various components of the environment 100 in communication with each other in a different manner. For example, a device of the user 102, the legal matter management system 108, and the map engine 110, may all, or in various combinations, be embodied within the enterprise system 106.

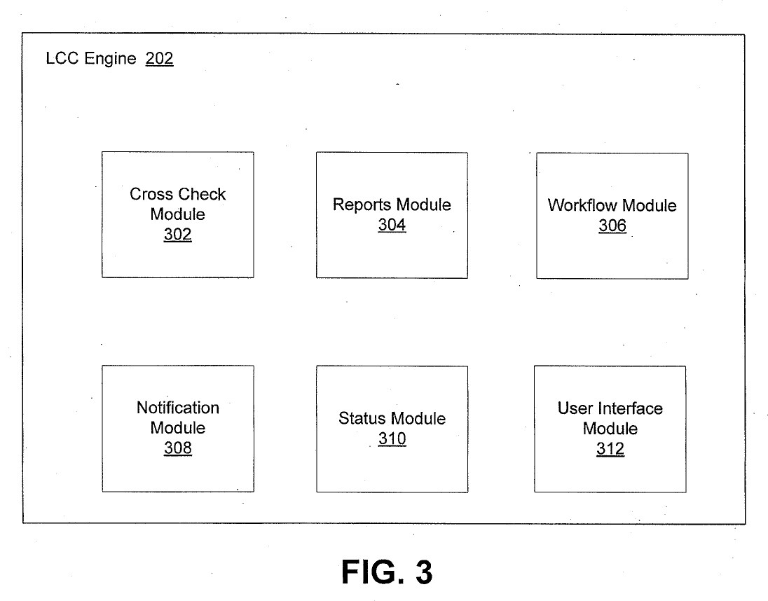

Referring now to FIG. 2, a detailed block diagram of the exemplary legal matter management system 108 is shown. In exemplary embodiments, the legal matter management system 108 comprises a legal communication and collections (LCC) engine 202, a litigation management engine 204, and a legal matter repository 206 configured for storing legal matter information. The LCC engine 202 will be discussed in more detail in connection with FIG. 3.

The litigation management engine 204 manages the legal matters within the enterprise system 106, and comprises a matter module 208, a scope management module 210, a derivation module 212, and a user interface module 214. Alternative embodiments may comprise more, less, or functionally equivalent modules. Furthermore, some of the modules of the litigation management engine 204 may be comprised in the map engine 110 or vice versa. While the litigation management engine 204 is discussed in a context of a litigation matter and search, alternative embodiments allow for the search to be associated with non-litigation matters, e.g. internal investigations, government regulatory request for information, etc.

In some embodiments, some of the components of the litigation management engine 204 are located at a device associated with the user 102, and operate within the device of the user to provide the functionalities described below. In other embodiments, the litigation management engine 204 is completely located at the device associated with the user 102. In yet other embodiments, the litigation management engine 204 is completely separate from the device of the user 102, and the user 102 accesses the litigation management engine 204 via the network 104.

The exemplary matter module 208 creates and maintains the legal matter which is managed by the legal matter management system 108. The legal matter identifies a matter for which affected people and systems are determined, e.g. derivation of a list of affected people and/or systems. The legal matter may also identify the attorneys and other staff that are working on the legal matter. By identifying the relevant staff, for example, a workflow may be automatically generated for the staff upon determination of the affected people and systems. Furthermore, results of the derivation may be stored based on the legal matter.

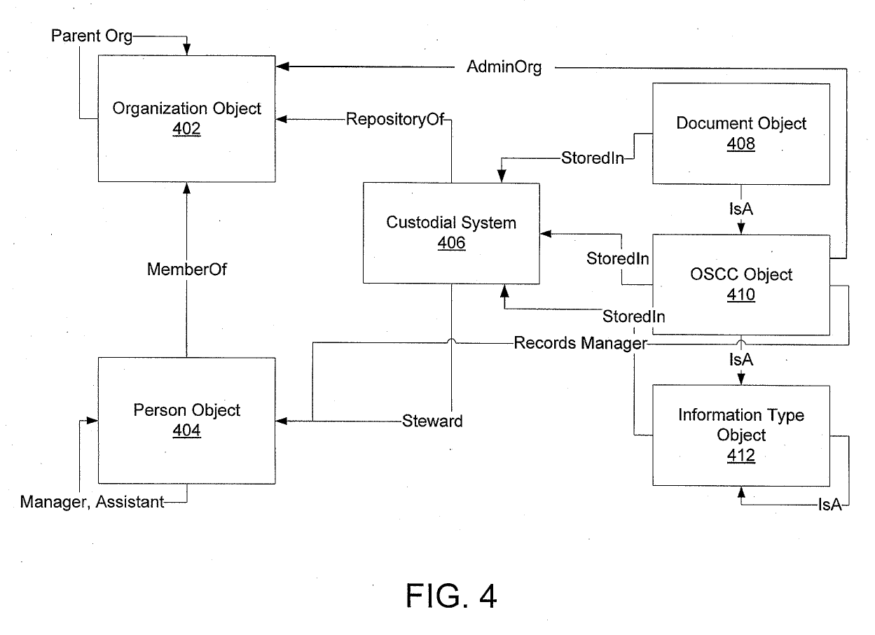

The scope management module 210 is configured to receive scope parameters from the user 102 for the derivation of key people and systems. In some embodiments, the scope management module 210 provides a graphical user interface (GUI) that allows the user 102 to provide the scope parameters. The scope parameters are one or more map objects that are known to intersect the legal matter in some manner. For example, if the legal matter involves a specific organization or information type, the user 102 can provide those objects as the scope parameters. Scope and map objects will be discussed in more detail in connection with FIG. 4.

The derivation module 212 takes the scope parameters and traverses the map to determine the affected people and systems associated with the legal matter, based on relationships identified within the map. In exemplary embodiments, the derivation module 212 may work with one or more components of the map engine 110 to traverse the map. Thus, knowing at least one root element, e.g. an object, associated with the legal matter, further objects and/or the affected people and systems may be derived. For example, for a given organization specific classification code (OSCC), items of data classified by the OSCC are stored in a particular information repository, e.g. file share or document management system. Typically, there is a steward, i.e. a person responsible for the information record keeping, for each repository. These stewards are affected people who must be notified about the legal matter.

Once the affected people and systems are identified by the derivation module 212, a list may be stored, for example, by legal matter. In exemplary embodiments, the list is stored in the legal matter repository 206, and comprises a list of people and systems with potential information or knowledge relevant to the legal matter. The affected people may comprise employees invoiced in the legal matter, IT staff responsible for managing data or information repositories associated with the legal matter, or records management staff responsible for the information record keeping associated with the legal matter. The list may be stored with additional information including attorney or paralegal data and matter status, e.g. active, closed.

Based on the results of the derivation, various workflow and notifications may be generated. The workflow and notifications will be discussed in more detail in connection with the LCC engine 202 in FIG. 3.

The exemplary user interface module 214 is configured to allow the user 102 to use the litigation management engine 204 to derive a list of affected people and/or systems. In some embodiments, the user interface module 214 provides a graphical user interface (GUI) that allows the user 102 to provide scope parameters to determine the affected people and systems. In further embodiments, the user interface module 214 provides GUIs for showing results of the derivation of affected people and systems. In some embodiments, the user interface module 214 may be optional.

The legal matter repository 206 may also store collected data from affected people and systems. As will be discussed further, a workflow may be generated for the collection of certain data from affected people and systems that are determined by the litigation management engine 204. According to exemplary embodiments, the collected data is stored in a central location, e.g. the legal matter repository 206. In alternative embodiments, the collected data may be stored in more than one legal matter repository 206.

The collected data may or may not be relevant to the legal matter. The user 102, in exemplary embodiments, may review the collected data to determine the relevancy or interest level.

In exemplary embodiments, a link is made between every data file that is put into the legal matter repository 206 and the custodian, e.g. affected person, or custodial system, e.g. affected system, from which the data file is collected or to which it is otherwise related. For example, if the file is shared between a plurality of users 102, the data in the data file may be collected from one user 102, but associated with other custodians, e.g. users 102 and/or custodial systems. The link may be implemented in various manners. In one embodiment, the data file may be stored with a unique file name. An associated table may record, for example, the custodian names, unique file name, and collection time. In an alternative embodiment, the data file may be tagged with the custodian names, thus establishing a connection between the custodians and the data file. In exemplary embodiments, a data file may be connected to any number of custodians or custodial systems, and therefore may be connected to a plurality of legal matters. For example, a critical contract or piece of e-mail may be relevant to a plurality of legal matters. In many of these cases, there may be one or more custodians or custodial systems that are relevant to a plurality of legal matters as well.

While FIG. 2 shows the LCC engine 202 and the litigation management engine 204 as separate engines, alternative embodiments may combine the two engines into a single engine. In further embodiments, some of the modules within the two engines 202 and 204 may be interchangeably placed in the other engine 204 and 202.

Referring now to FIG. 3, the exemplary LCC engine 202 is shown in more detail. The LCC engine 202 is configured to allow users 102 to manage communications and collections of data from affected people and systems. In exemplary embodiments, the LCC engine 202 may comprise a cross-check module 302, a reports module 304, a workflow module 306, a notification module 308, a status module 310, and a user interface module 312.

The exemplary cross-check module 302 is configured to perform a cross-check of affected people or systems, i.e. the custodian or custodial system, involved with one or more legal matters (see U.S. patent application Ser. No. 11/807,145, filed May 24, 2007 and entitled Conducting Cross Checks on Legal Holds across Custodian or Custodial System, which is incorporated herein in its entirety by this reference thereto). In some embodiments, the cross-check module 302 receives a criteria name, e.g. custodian or custodial system of interest or a matter of interest, from the user 102 and accesses the legal matter repository 206. In one embodiment, the cross-check module 302 reviews the legal matter repository 206 to determine all legal matters associated with the name of interest. In a further embodiment, the cross-check module 302 may trigger the derivation module 212 to determine a list of legal matters involving the name of interest. In some embodiments, the cross-check module 302 may perform the cross-check on active legal matters, inactive legal matters, or a combination of both active and inactive legal matters.

Based on the cross-check criteria, e.g. name, the cross-check module 302 determines the legal holds in effect for the custodian or custodial system across all matters. The cross-check module 302 may also determine a list of previously collected data from the custodian or custodial system. In exemplary embodiments, when the data is collected from the custodian or custodial system, the legal matter management system 108 also tracks when the data is collected. Thus, if the custodian is involved in a subsequent matter that may require the collection of previously collected data, the collection does not need to be performed again. In these embodiments, the custodian does not need to be placed under a legal hold, but may, in some embodiments, be placed under an advisory hold where they are reminded of their obligations, informed that the data is already collected, and/or requested to produce any new data not previously collected.

The reports module 304 provides a report of the results determined by the cross-check module 302. In exemplary embodiments, the reports module 304 organizes the results and presents the results to the user via the user interface module 312. The reports module 304 may also prepare reports for various audits based on the custodian, custodial systems, or legal matter. In some embodiments, the reports may be prepared based on templates.

In exemplary embodiments, once the litigation management engine 204 derives the list of affected people and systems for a legal matter, preservation of data or evidence may comprise sending legal hold notices to the affected people and planning and, in some cases, executing interviews with affected people. The exemplary legal hold notices instruct the affected people not to destroy data related to the legal matter. The interviews, in turn, may determine additional scope parameters to apply to the legal matter. The interviews may also identify more affected people and systems, which may or may not be within the enterprise system 106. For example, a contractor may have been involved on the legal matter.

In exemplary embodiments, the workflow module 306 is configured to generate a notification and/or collection workflow automatically. The notification workflow works in conjunction with the notification module 308 to notify the affected people and administrators of affected systems. The collection workflow provides plans and plan executions to drive the collection of data and evidence associated with the legal matter. The collection plans target collection from the affected people, e.g. custodians, and systems, e.g. custodial systems and their respective steward.

A key aspect of the LCC engine and, in particular the workflow module and notification module (discussed below), includes functions to identify and record custodial systems involved or potentially involved in a legal matter and employees responsible for the systems, e.g. associated stewards and business owners; and to send legal notices to employees indicating actions to be taken including, for example, in connection with information, i.e. a hold notice indicating the requirement and obligation to preserve information; knowledge, i.e. an interview request indicating the need to share or disclose knowledge; and documents, i.e. a request to collect and produce information.

This embodiment of the invention operates in connection with a coupling between the LCC and sources of information about custodial system attributes, status, and associations with other entities in the enterprise map and which may comprise, for example an application, i.e. user interface, in the LCC or in another stand-alone application, that allows custodial system information, status changes or expected status changes, and associations between custodial systems/employees/OSCCs/departments to be entered, a central application for aggregating status information from various sources, or other system that can be a source of information.

The notification module 308 sends the legal notices to preserve data and to produce the data or evidence. In some embodiments, the legal notices may be sent to the legal staff and instruct the legal staff on how and when to perform production. In alternative embodiments, the legal notices may be sent to one or more of the affected people with instructions on how and when to perform production.

The exemplary status module 310 is configured to maintain status for requests associated with a legal matter. Each legal matter may comprise one or more requests to the affected people or systems.

The user interface module 312 is configured to allow the user 102 to use the LCC engine 202 to perform the various user functions discussed herein. In some embodiments, the user interface module 310 provides a graphical user interface (GUI) that allows the user 102 to selected affected people/systems or a particular legal matter. In further embodiments, the user interface module 310 provides GUIs for showing results. It should be noted that the functions of the user interface module 216 of the litigation management engine 204 and the user interface module 310 of the LCC engine 202 may be combined into a single user interface module located in either engine 202 or 204.

As previously discussed, some of the modules within the litigation management engine 204 and the LCC engine 202 may be interchangeably placed in the other engine 202 and 204. For example, the workflow module 306 and the notification module 308 may be comprised within the litigation management engine 204.

Referring now to FIG. 4, a schematic diagram of exemplary relationships between primary objects within a map of the enterprise system 106 is shown. Based on these relationships, a list of affected people and/or systems may be derived by the derivation module 212. Exemplary embodiments of the invention take advantage of the fact that people have certain types of relationships to organizations, and information repositories have a responsible person/people, i.e. stewards, and associated disposal and retention policies. As discussed herein, the map establishes exemplary relationships between the objects as shown. In exemplary embodiments, an object comprises data or metadata associated with information stored in the legal matter repository 206.

In exemplary embodiments, each document is classified with an organization specific classification code (OSCC). The OSCC identifies both an information type and an organization within a single classification code. Any number of organizations may comprise the enterprise system 106. For example, ADM-212 may be an OSCC only used by a New York office, i.e. organization, of an investment bank to classify administrative internal memos, i.e. information type.

Because the OSCC provides an intrinsic relationship between the organization, information type, and any policies associated with the OSCC, a user 102 is able to find relevant information more easily and quickly. Based on people, custodians, organizations, or information types known to be relevant to a legal matter, for example, a subset of all enterprise OSCCs can be derived that are relevant to the legal matter. More specifically, the user 102 can search for a specific OSCC and identify systems and people associated with the legal matter. In further embodiments, the user 102 may search for and identify exact data and/or evidence that are classified with a given OSCC.

An organization object 402 includes information about the organization or other groupings of people. In some embodiments, these organizations may be hierarchically organized. Any type of organization object 402 may be used. For example, the organization object 402 may include a name of the organization, a parent organization, persons in the organization, repositories or storage mediums used by the organization, geography associated with the organization, organization locations, accounting codes, and so forth. One or more organizations may be represented by the organization object 402. The one or more organizations may be designated according to a hierarchical structure, such as a parent organization.

A person object 404 represents an individual with a role within the organization. For example, the person object 404 may include an employee in the organization. The person object 404 may be associated with one or more items of information by a name, contact information, role in the organization, relationship with other persons 404, organizational affiliations, repository affiliations, responsibilities, job title, and so forth. The person object 404 may be related to the organization object 402 by virtue of a “MemberOf” relationship, which indicates that each person is a member of one or more organizations. For example if a person works at a NY office of an investment bank, the user, i.e. person object 404, is affiliated with the NY office, i.e. organization object 402.

A custodial system object 406 represents storage locations. The custodial system object 406 may include any electronic or non-electronic information repositories, such as a warehouse, a file server, or any other storage mediums. The custodial system object 406 may include or be related to name, system type and details, physical location, network location, access methods, stewards, i.e. the persons and the person object 404 responsible, the organizations that use the custodial system, e.g. organization object 402, information types stored in the custodial system, e.g. information type object 412, and so forth. Accordingly, the custodial system object 406 has a relationship with the other objects shown in FIG. 4.

A document object 408 represents information about documents, papers, text, files, metadata, and other items of data stored in a custodial system, e.g. repository. The information represented by the document object 408 is thus related to the custodial system object 406 by being stored in the custodial system identified by the custodial system object 406.

An OSCC object 410 is associated with a classification code, i.e. the OSCC, assigned to each item of data associated with the document object 408. The OSCC object 410 may indicate information type, location in the custodial system object 406 for the information, policy information, such as a records manager, and so forth. Once the OSCC object 410 is assigned to the item of data associated with the document object 408, the classification may be stored in a repository associated with the custodial system object 406. Each classification may be associated with one or more persons responsible for managing the information assigned the specific classification. Thus, the person object 404 may be related to the OSCC object 410.

In exemplary embodiments, information represented by the document object 408 is related to the OSCC object 410 by a hierarchical taxonomy of types. In other words, the information represented by the document object 408 may include OSCC data and be organized according to the OSCC data.

An information type object 412 is associated with the OSCC object 410 classification. The items of data may be organized as a hierarchical taxonomy, for example, using the information type. The information type object 412 may include name, identifiers, such as record keeping codes, parent type, repository affiliations, i.e. default location for the information, organization affiliations, and so forth. An information type is a broad class of information, such as “Accounting Invoice” or “Quarterly Financial Report,” for example. A data type or document may, optionally, be associated with one or more repositories via the custodial system object 406 discussed herein. Accordingly, the information type object 412 is related to the custodial system object 406 and to the OSCC object 410. In exemplary embodiments, the OSCC is a more specific class of information that a given information type uses within a given organization.

The map engine 108 uses the relationships between the various objects described in FIG. 4 to generate the map. Subsequently, the derivation module 212 can determine the people and systems involved with a legal matter, and the cross-check module 302 can determine if the people or systems are associated with a plurality of legal matters. Although FIG. 4 specifies the relationship between the various objects and the various objects that may have specified relationships, further embodiments may also comprise other objects and/or relationships between the objects and still fall within the scope of various embodiments.

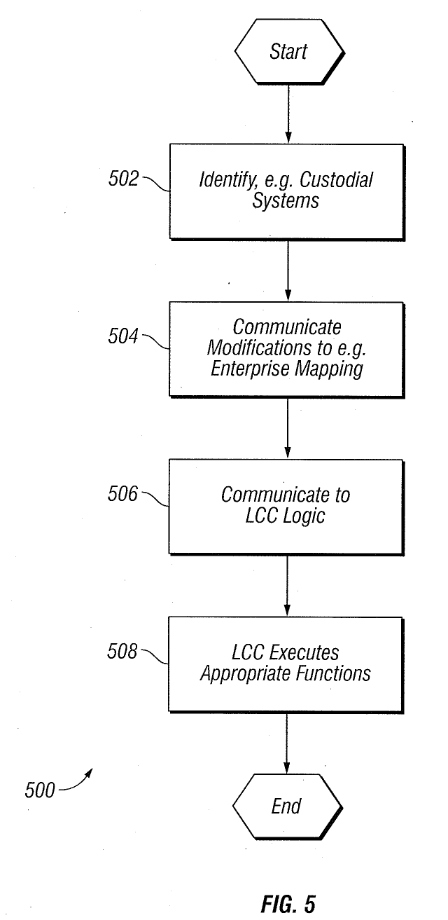

FIG. 5 is a flowchart 500 of an exemplary method for proactively determining potential evidence issues for custodial systems in active litigation across the enterprise system 106. In step 502, attorneys, paralegals, and other LCC users use the LCC application to identify the custodial systems involved and affected by legal matters, as well as the list of employees involved due to their association with an affected custodial system. In exemplary embodiments, this list is stored per legal matter and may include, for example systems associated with the departments involved in the matter; global systems; custodial systems mapped to the information types relevant to the matter; any other system intersecting the matter; IT staff responsible for managing data or information repositories; and records management staff responsible for information record keeping. Additional information about the matter, such as the Attorney and Paralegal and matter status (Active, Closed), is also stored in this system.

At step 504, as custodial system attributes, status, or mapping associations change or are expected to change, the modification is communicated, signaled, queued, tagged, or otherwise indicated in an appropriate system, such as the enterprise mapping, and even directly into the LCC application itself. The change event signals the following information for one or more custodial systems, such as expected or actual status change indicating that the system is to be taken off line; changes in relationships between custodial systems, e.g. change in back-up system used; enterprise map changes that cause data migration; and employee status or role assignment changes affecting custodial systems.

In step 506, the custodial system change event is communicated to the LCC application logic. The event minimally contains, for example an ID or other unique identifier indicating which custodial system is affected; optionally, the expected or actual end date of operation, which may be past or future, if known; and optionally, other custodial system information, including associations with other entities in the enterprise map.

Multiple events may be communicated for the same custodial system in case of several changes, e.g. multiple new or modified relationships between custodial systems or associations with other entities in the enterprise map.

In step 508, based upon the change events, the LCC application performs a variety of functions, for example provide a notification, where appropriate parties, such as relevant business department and IT staff, are notified of the event so that action can be taken to preserve the information. In some embodiments of the present invention, one or more “notification list” is provided that lists the appropriate parties who should receive this information. For each legal matter that is currently Active, the list of involved and affected custodial systems for the system indicated in the event is searched. If the system is found in the matter, then notify (alert) one or more individuals selected from among an Attorney, a Paralegel and other appropriate individuals on the one or more notification list for each Matter that swift action needs to be taken to preserve the data; send a legal notice to appropriate staff associated with the custodial system, such as IT, business owners, etc., informing them of the preservation obligations regarding the system; and if a legal notice was sent, record the legal notice, date of transmission and all notice recipients in the LCC application to create an audit trail.

In another function, a workflow may be implemented, where workflow processes can be triggered to manage the collection and processing, providing instructions, assignment, tracking of timely task completion, and exception handling for errors or incomplete tasks. The LCC application creates workflow items to track the status of the information preservation, and to prompt relevant employees, e.g. attorney, paralegal, IT, to confirm and validate that actions have been taken, and to handle exceptions when this is not done in a timely manner. This workflow can be driven by the actual status of the custodial system within each active legal Matter, i.e.: Are there legal holds? Are there open collection requests?, etc.

In yet another function, a reporting, where search and reporting tools provide a list of all matters involving the custodial system, including the status of information that may have been or may need to be collected/preserved.

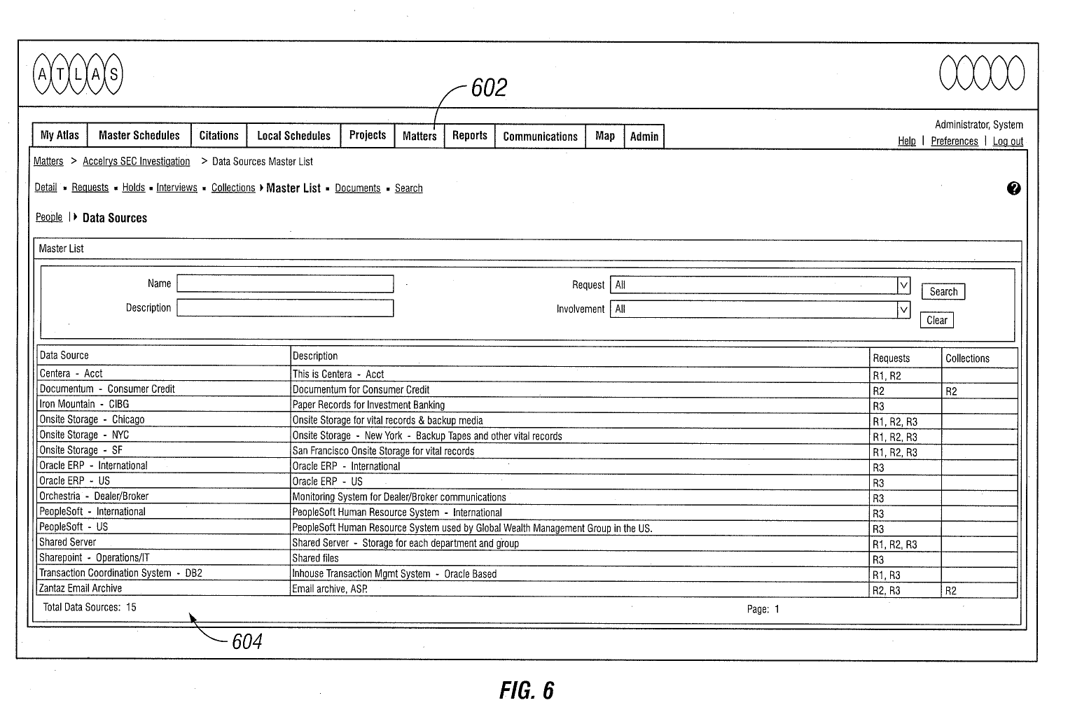

FIG. 6 is a screen shot showing the Matters tab 602 selected for the matter “Accelrys SEC Investigation.” The data sources master list 604, consisting of fifteen total data sources, is displayed. For each data source, a Description, Requests, and Collections status is provided. The data sources or custodial systems master list indicates all affected systems that are either previously or currently associated with the matter. This is important in the demonstrating diligence and thoroughness of evidence collection and preservation for the legal matter.

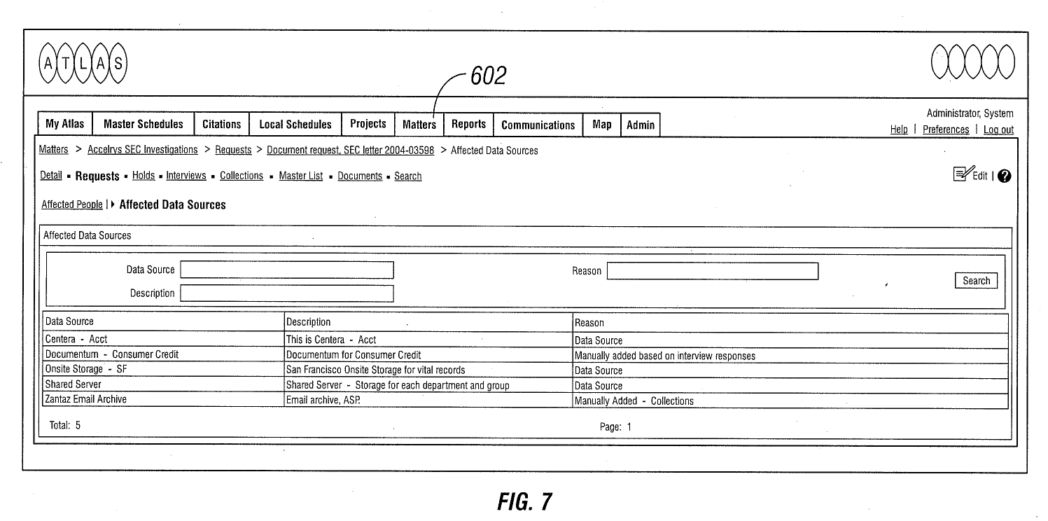

FIG. 7 is a screen shot showing the Matters tab 602 selected for the matter “Accelrys SEC Investigation.” In FIG. 7, affected data sources for document request “SEC letter 2004-03598” are listed, along with a description and reason(s) why the systems are associated with the legal matter. For example, for the Zantaz Email Archive, collections were manually added. The list can be edited by selecting an edit icon. Thus if attorney determines (i.e. via an interview, research, or based on a status change notification) that more systems should be added to the list the attorney may do so.

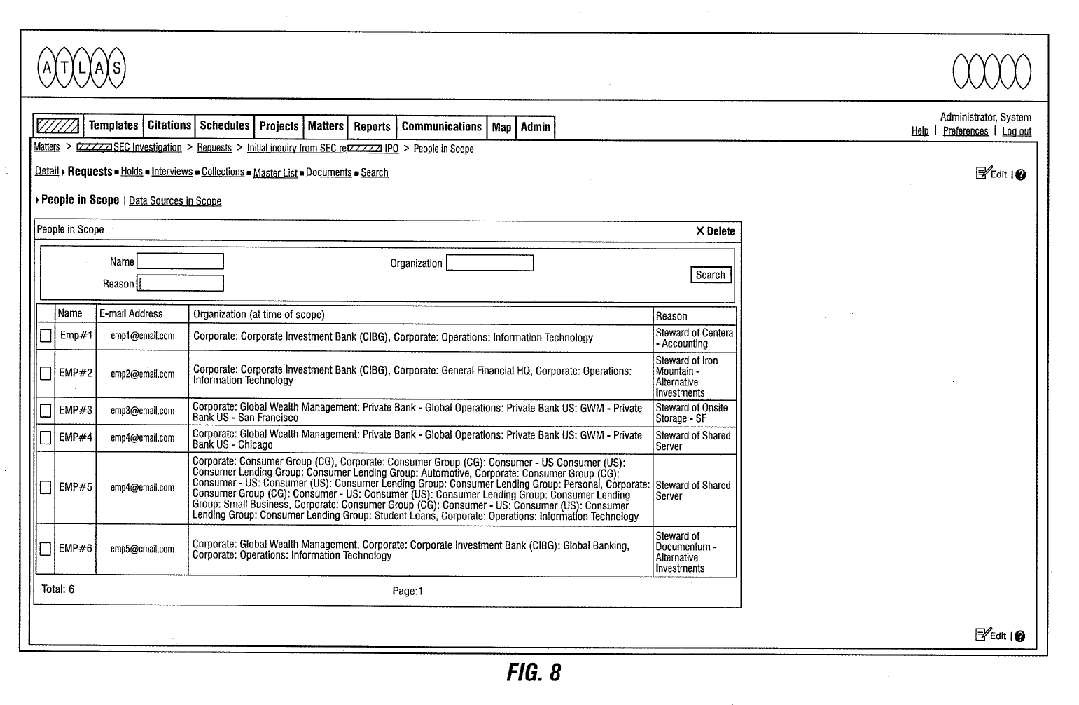

FIG. 8 is a screenshot of a user interface providing a list of affected people. In exemplary embodiments, this list is generated based on some search parameter which is cross-checked against a list of all legal matters. In one embodiment, the list of FIG. 6 may contain employees added due to their relationships with custodial systems. This list may be edited by selecting an edit icon. Thus, if the relationships between custodial systems and their stewards or other employees changes, the affected people list can be modified accordingly.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A computer implemented method for proactively determining potential evidence issues for custodial systems in active litigation, comprising the steps of:
creating a record of custodial systems' involvement in legal matters;
providing a workflow that detects actual or planned changes affecting custodial systems themselves and/or their associations with other entities in an enterprise map;
coupling said record of custodial systems' involvement in legal matters with said workflow; and
notifying appropriate parties of said actual or planned changes affecting custodial systems themselves and/or their associations with other entities in an enterprise map.

2. The method of claim 1, further comprising the step of:
providing a legal communications and collections (LCC) application, said LCC providing a mechanism for allowing attorneys and paralegals to manage preservation and production of information, said LCC executing the steps of:
identifying and recording custodial systems involved or potentially involved in a legal matter and employees responsible for the systems;
sending legal notices to employees indicating actions to be taken, said action taken in connection with any of:
information by providing a hold notice indicating a requirement and obligation to preserve information;
knowledge by providing an interview request indicating a need to share or disclose knowledge; and
documents by providing a request to collect and produce information;

3. The method of claim 1, further comprising the step of:
providing sources of information about custodial system attributes, status, and associations with other entities in an enterprise map.

4. The method of claim 3, said sources of information comprising any of:
an application for allowing custodial system information, status changes or expected status changes, and associations between custodial systems/employees/OSCCs/departments to be entered;
a central application for aggregating status information from various sources; and
other system that can be a source of information.

5. A computer implemented method for proactively determining potential evidence issues for custodial systems in active litigation, comprising the steps of:
providing a legal communications and collections (LCC) application, said LCC providing a mechanism for allowing attorneys, paralegals, and other LCC users to identify custodial systems involved and affected by legal matters, as well as a list of employees involved due to their association with an affected custodial system;
storing said list per legal matter, said list comprising any of:
systems associated with departments involved in a matter;
global systems;
custodial systems mapped to information types relevant to a matter;
any other system intersecting a matter;
IT staff responsible for managing data or information repositories; and
records management staff responsible for information record keeping;
storing additional information about a matter, comprising any of an attorney, paralegal, and matter status (Active, Closed);
communicating, signaling, queuing, tagging, or otherwise indicating modifications in an appropriate system as custodial system attributes, status, or mapping associations change or are expected to change;
providing a change event that signals any of the following information for one or more custodial systems:
expected or actual status change indicating that a system is to be taken off line;
changes in relationships between custodial systems;
enterprise map changes that cause data migration; and
employee status or role assignment changes affecting custodial systems;
communicating custodial system change events to said LCC application, said events minimally comprising an ID or other unique identifier indicating which custodial system is affected, and optionally comprising any of an expected or actual end date of operation, which may be past or future, if known; and other custodial system information, including associations with other entities in an enterprise map;
based upon said change events, said LCC application performing any of the following functions:
notifying appropriate parties of said event so that action can be taken to preserve information, wherein for each legal matter that is currently Active, a list of involved and affected custodial systems for a system indicated in said event is searched, and wherein if a system is found in a matter, then;
notifying (alerting) one or more individuals selected from among an Attorney, a Paralegel and other appropriate individuals on one or more notification lists;
sending a legal notice to appropriate staff associated with a custodial system informing them of preservation obligations regarding said system; and
if a legal notice was sent, recording said legal notice, date of transmission, and all notice recipients in said LCC application to create an audit trail;
triggering workflow processes to manage collection and processing, providing instructions, assignment, tracking of timely task completion, and exception handling for errors or incomplete tasks;
said LCC application creating workflow items to track status of information preservation, to prompt relevant employees to confirm and validate that actions have been taken, and to handle exceptions when this is not done in a timely manner;
providing search and reporting tools in connection with a list of all matters involving a custodial system, including status of information that may have been or may need to be collected/preserved.

6. A computer implemented method for proactively determining potential evidence issues for custodial systems in active litigation, comprising the steps of:
providing a legal communications and collections (LCC) application, said LCC providing a mechanism for allowing attorneys, paralegals, and other LCC users to identify custodial systems involved and affected by legal matters, as well as a list of employees involved due to their association with an affected custodial system;
communicating, signaling, queuing, tagging, or otherwise indicating modifications in an appropriate system as custodial system attributes, status, or mapping associations change or are expected to change; and
communicating custodial system change events to said LCC application, said events minimally comprising an ID or other unique identifier indicating which custodial system is affected.

7. The method of claim 6, further comprising the step of:
based upon said change events, said LCC application performing any of the following functions:
notifying appropriate parties of said event so that action can be taken to preserve information, wherein for each legal matter that is currently Active, a list of involved and affected custodial systems for a system indicated in said event is searched, and wherein if a system is found in a matter, then;
notifying (alerting) one or more individuals selected from among an Attorney, a Paralegel and other appropriate individuals on one or more notification lists;
sending a legal notice to appropriate staff associated with a custodial system informing them of preservation obligations regarding said system; and
if a legal notice was sent, recording said legal notice, date of transmission, and all notice recipients in said LCC application to create an audit trail;
triggering workflow processes to manage collection and processing, providing instructions, assignment, tracking of timely task completion, and exception handling for errors or incomplete tasks;
said LCC application creating workflow items to track status of information preservation, to prompt relevant employees to confirm and validate that actions have been taken, and to handle exceptions when this is not done in a timely manner;
providing search and reporting tools in connection with a list of all matters involving a custodial system, including status of information that may have been or may need to be collected/preserved.

8. The method of claim 6, said storing step further comprising the steps of:
storing said list per legal matter, said list comprising any of:
systems associated with departments involved in a matter;
global systems;
custodial systems mapped to information types relevant to a matter;
any other system intersecting a matter;
IT staff responsible for managing data or information repositories; and
records management staff responsible for information record keeping; and
storing additional information about a matter, comprising any of an attorney, paralegal, and matter status (Active, Closed).

9. The method of claim 6, further comprising the step of:
providing a change event that signals any of the following information for one or more custodial systems:
expected or actual status change indicating that a system is to be taken off line;
changes in relationships between custodial systems;
enterprise map changes that cause data migration; and
employee status or role assignment changes affecting custodial systems.

10. The method of claim 6, said custodial system change events further comprising any of:
an expected or actual end date of operation, which may be past or future, if known; and
other custodial system information, including associations with other entities in an enterprise map.

11. The method of claim 6, wherein custodial systems that are involved or affected by a legal matter comprise systems derived using a key player identification algorithms.

12. The method of claim 7, said notification step comprising any of the step of:
alerting an attorney and/or paralegal by email, pager, or any other common method; and
effecting escalation and wider alerting when very swift reaction by a legal team is required.

13. The method of claim 6, further comprising the step of:
sending a legal notice to appropriate staff;
wherein IT staff that assume system responsibility are notified of actions that must be taken, wherein a workflow is used to track action completion;
wherein in case of system retirement, IT staff responsible for a custodial system are notified of actions that must be taken, wherein a workflow is used to track action completion; and
wherein records management and compliance personnel responsible for stored information are notified, wherein appropriate parties are identified from a directory of records management/compliance personnel by organization.

14. The method of claim 6, further comprising the step of:
legal staff using said LCC application for actively monitoring custodial system attribute and status changes, and for processing said system attribute and status changes by any of the steps of:
subscribing to status change notifications and/or seeing summary reports of all status changes that have occurred, wherein said summary reports show any of custodial systems with outstanding collections, a list of affected custodial systems for a single matter, or any other permutation thereof;
seeing workflow status to identify any of whether preservation efforts have been taken and exceptions (overdue) actions;
providing dashboard functionality that summarizes said system attribute and status changes; and
providing review/audit capability for said system attribute and status changes.

15. The method of claim 6, further comprising the steps of:
creating a record (history) of all steps, intervention, and collection of information from a custodial system affected by changes during a matter; and
making said record part of a preservation and matter record.

16. An apparatus for proactively determining potential evidence issues for custodial systems in active litigation, comprising:
means for creating a record of custodial systems' involvement in legal matters;
a workflow that detects actual or planned changes affecting custodial systems themselves and/or their associations with other entities in an enterprise map;
means for coupling said record of custodial systems' involvement in legal matters with said workflow; and
means for notifying appropriate parties of said actual or planned changes affecting custodial systems themselves and/or their associations with other entities in an enterprise map.

17. The apparatus of claim 16, further comprising:
a legal communications and collections (LCC) application, said LCC providing a mechanism for allowing attorneys and paralegals to manage preservation and production of information, said LCC executing computer code for implementing the steps of:
identifying and recording custodial systems involved or potentially involved in a legal matter and employees responsible for the systems;
sending legal notices to employees indicating actions to be taken, said action taken in connection with any of:
information by providing a hold notice indicating a requirement and obligation to preserve information;
knowledge by providing an interview request indicating a need to share or disclose knowledge; and
documents by providing a request to collect and produce information;

18. The apparatus of claim 16, further comprising:
one or more sources of information about custodial system attributes, status, and associations with other entities in an enterprise map.

19. The apparatus of claim 18, said sources of information comprising any of:
an application for allowing custodial system information, status changes or expected status changes, and associations between custodial systems/employees/OSCCs/departments to be entered;
a central application for aggregating status information from various sources; and
other system that can be a source of information.

20. An apparatus for proactively determining potential evidence issues for custodial systems in active litigation, comprising:
a legal communications and collections (LCC) application, said LCC providing a mechanism for allowing attorneys, paralegals, and other LCC users to identify custodial systems involved and affected by legal matters, as well as a list of employees involved due to their association with an affected custodial system;
a memory for storing said list per legal matter, said list comprising any of:
systems associated with departments involved in a matter;
global systems;
custodial systems mapped to information types relevant to a matter;
any other system intersecting a matter;
IT staff responsible for managing data or information repositories; and
records management staff responsible for information record keeping;
a memory for storing additional information about a matter, comprising any of an attorney, paralegal, and matter status (Active, Closed);
means for communicating, signaling, queuing, tagging, or otherwise indicating modifications in an appropriate system as custodial system attributes, status, or mapping associations change or are expected to change;
means for providing a change event that signals any of the following information for one or more custodial systems:
expected or actual status change indicating that a system is to be taken off line;
changes in relationships between custodial systems;
enterprise map changes that cause data migration; and
employee status or role assignment changes affecting custodial systems;
means for communicating custodial system change events to said LCC application, said events minimally comprising an ID or other unique identifier indicating which custodial system is affected, and optionally comprising any of an expected or actual end date of operation, which may be past or future, if known;
and other custodial system information, including associations with other entities in an enterprise map;
based upon said change events, said LCC application executing computer code for performing any of the following functions:
notifying appropriate parties of said event so that action can be taken to preserve information, wherein for each legal matter that is currently Active, a list of involved and affected custodial systems for a system indicated in said event is searched, and wherein if a system is found in a matter, then;
notifying (alerting) one or more individuals selected from among an Attorney, a Paralegel and other appropriate individuals on one or more notification lists;
sending a legal notice to appropriate staff associated with a custodial system informing them of preservation obligations regarding said system; and
if a legal notice was sent, recording said legal notice, date of transmission, and all notice recipients in said LCC application to create an audit trail;
triggering workflow processes to manage collection and processing, providing instructions, assignment, tracking of timely task completion, and exception handling for errors or incomplete tasks;
said LCC application creating workflow items to track status of information preservation, to prompt relevant employees to confirm and validate that actions have been taken, and to handle exceptions when this is not done in a timely manner;
providing search and reporting tools in connection with a list of all matters involving a custodial system, including status of information that may have been or may need to be collected/preserved.

21. An apparatus for proactively determining potential evidence issues for custodial systems in active litigation, comprising:
a legal communications and collections (LCC) application, said LCC providing a mechanism for allowing attorneys, paralegals, and other LCC users to identify custodial systems involved and affected by legal matters, as well as a list of employees involved due to their association with an affected custodial system;
means for communicating, signaling, queuing, tagging, or otherwise indicating modifications in an appropriate system as custodial system attributes, status, or mapping associations change or are expected to change; and
means for communicating custodial system change events to said LCC application, said events minimally comprising an ID or other unique identifier indicating which custodial system is affected.

22. The apparatus of claim 21, further comprising:
based upon said change events, said LCC application executing computer code for performing any of the following functions:
notifying appropriate parties of said event so that action can be taken to preserve information, wherein for each legal matter that is currently Active, a list of involved and affected custodial systems for a system indicated in said event is searched, and wherein if a system is found in a matter, then:
notifying (alerting) one or more individuals selected from among an Attorney, a Paralegel and other appropriate individuals on one or more notification lists;
sending a legal notice to appropriate staff associated with a custodial system informing them of preservation obligations regarding said system; and
if a legal notice was sent, recording said legal notice, date of transmission, and all notice recipients in said LCC application to create an audit trail;
triggering workflow processes to manage collection and processing, providing instructions, assignment, tracking of timely task completion, and exception handling for errors or incomplete tasks;
said LCC application creating workflow items to track status of information preservation, to prompt relevant employees to confirm and validate that actions have been taken, and to handle exceptions when this is not done in a timely manner; and
providing search and reporting tools in connection with a list of all matters involving a custodial system, including status of information that may have been or may need to be collected/preserved.

23. The apparatus of claim 21, said memory further comprising:
a memory for storing said list per legal matter, said list comprising any of:
systems associated with departments involved in a matter;
global systems;
custodial systems mapped to information types relevant to a matter;
any other system intersecting a matter;
IT staff responsible for managing data or information repositories; and
records management staff responsible for information record keeping; and
a memory for storing additional information about a matter, comprising any of an attorney, paralegal, and matter status (Active, Closed).

24. The apparatus of claim 21, further comprising:
means for providing a change event that signals any of the following information for one or more custodial systems:
expected or actual status change indicating that a system is to be taken off line;
changes in relationships between custodial systems;
enterprise map changes that cause data migration; and
employee status or role assignment changes affecting custodial systems.

25. The apparatus of claim 21, said custodial system change events further comprising any of:
an expected or actual end date of operation, which may be past or future, if known; and
other custodial system information, including associations with other entities in an enterprise map.

26. The apparatus of claim 21, wherein custodial systems that are involved or affected by a legal matter comprise systems derived using a key player identification algorithms.

27. The apparatus of claim 22, said notification means comprising any of means for:
alerting an attorney and/or paralegal by email, pager, or any other common method; and
effecting escalation and wider alerting when very swift reaction by a legal team is required.

28. The apparatus of claim 21, further comprising:
means for sending a legal notice to appropriate staff;
wherein IT staff that assume system responsibility are notified of actions that must be taken, wherein a workflow is used to track action completion;
wherein in case of system retirement, IT staff responsible for a custodial system are notified of actions that must be taken, wherein a workflow is used to track action completion; and
wherein records management and compliance personnel responsible for stored information are notified, wherein appropriate parties are identified from a directory of records management/compliance personnel by organization.

29. The apparatus of claim 21, said LCC application further comprising:
means for legal staff to actively monitor custodial system attribute and status changes, and for processing said system attribute and status changes by any of:
subscribing to status change notifications and/or seeing summary reports of all status changes that have occurred, wherein said summary reports show any of custodial systems with outstanding collections, a list of affected custodial systems for a single matter, or any other permutation thereof;
seeing workflow status to identify any of whether preservation efforts have been taken and exceptions (overdue) actions;
providing dashboard functionality that summarizes said system attribute and status changes; and
providing review/audit capability for said system attribute and status changes.

30. The apparatus of claim 21, further comprising:
means for creating a record (history) of all steps, intervention, and collection of information from a custodial system affected by changes during a matter; and
means for making said record part of a preservation and matter record.
